(19) United States
(12) Patent Application Publication
(10) Pub. No.: US 2021/0308925 A1
(43) Pub. Date: Oct. 7, 2021

(54) DEVICE FOR FORMING A PLASTIC COMPONENT

(71) Applicant: KRAUSSMAFFEI TECHNOLOGIES GMBH, München (DE)

(72) Inventors: Markus Agerer, Olching Bayern (DE); Sebastian Schmidhuber, München (DE); Robert Brunner, Augsburg (DE)

(21) Appl. No.: 17/273,790

(22) PCT Filed: Oct. 31, 2018
(86) PCT No.: PCT/EP2018/079809

§ 371 Date: Mar. 5, 2021

(30) Foreign Application Priority Data
Sep. 18, 2018 (DE) 10 2018 122 797.3

(51) Int. Cl. B29C 48/00; B29B 7/74; B29B 7/76; B29C 70/52; B29C 48/09; B29C 48/21; B29C 48/30; B29C 48/32; B29C 48/335; B29C 48/36; B33Y 80/00

(52) U.S. Cl. CPC B29C 48/0012; B29B 7/7404; B29B 7/7457; B29B 7/7631; B29C 70/52; B29C 48/09; B29K 2075/00; B29C 48/3001; B29C 48/304; B29C 48/32; B29C 48/335; B29C 48/362; B33Y 80/00; B29C 48/21

(57) ABSTRACT

A device for forming a plastic component, which device has a body which is suitable for use in a device for producing a plastic component from a first compound, and which is formed in such a way that, when used in the device for producing plastic components, by being guided past the body, the first compound is brought into a form which has at least one cavity which is continuous in the direction of the guiding past. The device additionally has a line system arranged in the body, through which a second compound can be expelled from an end of the body, in order to introduce a second compound into the cavity while the first compound is guided past the body.

The present invention relates to a device for forming a plastic component with at least one cavity, which can be used in devices for producing plastic components by means of pultrusion or extrusion. In particular, the present invention relates to such devices by which at the same time as the producing of plastic components with cavities, a compound can be introduced into the cavity.

It is known to produce plastic components in endless manufacture. For this, usually pultrusion methods (also designated as strand-drawing methods) or extrusion methods are used.

Pultrusion methods constitute continuous production methods for the manufacture of (fibre-reinforced) plastic profiles. For this, endless fibres (or else other semi-finished forms, inlays, fabrics or inserts) are mixed with plastic (polyurethane, polyamide, epoxy resin or suchlike) in a pultrusion tool, and are formed to a profile. These profiles can also be manufactured with one cavity or several cavities. In order to be able to produce cavities, usually so-called cores must be introduced into the tool. The mixture of endless fibre and plastic is then guided around the core and hardens on being guided past the core, so that at the end of the core a plastic component is present having a continuous cavity corresponding to the diameter of the core. This can then be fed to further processing steps. An example of plastic components produced by pultrusion are frames for plastic windows, the profiles of which are pultruded before they are cut and joined to the frame.

In extrusion methods, solid to viscous, usually thermoplastic, hardenable compounds are pressed out continuously under pressure out of a shaping opening (also designated as nozzle, matrix, mouthpiece or extrusion mask). Here, bodies are produced having the cross-section of the opening, designated extrudate, in theoretically any desired length. Methods are known here in which two tubes are extruded into one another, wherein the space between the two tubes can be foamed with polyurethane (PUR).

A foaming of profiles and other hollow components, inter alia with PUR, is carried out e.g. for the purposes of thermal insulation. An example of this are double-walled tubes which are produced by the extrusion method and in which the outer cavity is foamed with PUR by means of a PUR metering system. Another example are refrigerators, in which likewise a cavity between an outer and inner housing is filled by PUR. The foaming of window profiles for thermal insulation is also known.

With the systems or respectively methods known from the prior art, it is not possible, however, to form plastic components in one step and additionally to fill them with a further material, such as for instance a plastic foam.

For example, in the pultrusion method, fibre-reinforced plastic profiles can, indeed, be produced continuously. However, these are either filled in the interior with a plastic-fibre mixture of the same type or are internally hollow. A simultaneous foaming (“online” during the pultrusion process) of the cavity is not possible with the conventional pultrusion systems.

In particular, the foaming of window profiles made of PVC takes place in a discontinuous method, because the temperatures at the sites of the production process are too high at which a PUR input would be possible. However, the discontinuous foaming of the sawn profiles represents additional costs compared to a continuous foaming process directly during the production of the profile.

In the extrusion method currently the foaming of double-walled tubes takes place before the extrusion of the outer tube. The PUR insulation layer is pre-formed in a relatively laborious manner after the applying onto the inner tube. Thereafter, the outer tube is extruded over the PUR layer. The method is very laborious and hence costly. The subsequent foaming of the intermediate space between the two tubes, which are already brought together, is also difficult by the usual methods and is not possible continuously.

It is therefore an object of the present invention to solve these problems and to indicate a device by which a plastic component can be brought into a form with at least one cavity, and the cavity can be simultaneously filled entirely or partially with a compound.

This problem is solved by the subject of the independent claims. Advantageous further developments are indicated in the dependent claims.

A device for forming a plastic component can have a body which is suitable for use in a device for producing plastic components from a first compound, and which is formed in such a way that, when used in the device for producing plastic components, the first compound, by being guided past the body, is brought into a form which has at least one cavity, which is continuous in the direction of the guiding past. The device has here a line system arranged in the body, through which a second compound can be expelled from an end of the body, in order to introduce the second compound into the body while the first compound is guided past the body.

The device therefore consists of a body which, in a device for producing plastic components, in particular in a pultrusion or extrusion tool, is flowed around by the raw material of the plastic component (fibre-plastic mixture in the pultrusion, thermoplastic compounds in the extrusion). Hereby, the body of the (first) compound from which the plastic component is manufactured impresses its form in such a way that downstream of the flow direction of the process at least one cavity occurs in the compound or respectively in the plastic component. The body can have e.g. the form of a core, which is conventionally used in a pultrusion tool, or the form of an extrusion mask, which is conventionally used in an extrusion tool.

In order to now introduce a further second compound, differing from the first compound at least in its physical characteristics, such as density, viscosity, aggregate state or suchlike, into the cavity which is produced hereby, the body has a line system through the which the second compound is guided through the body to an outlet which opens into the cavity. The second compound is therefore guided through the line system to an end of the body and is expelled from there into the cavity. The end or respectively the side of the body with the outlet therefore points in flow direction of the process, i.e. is arranged downstream in flow direction.

In this way, the second compound can be introduced into the cavity in the first compound, produced by the presence of the body, or respectively in the plastic component, while the first compound is guided past the body, i.e. while the plastic component is manufactured.

A filling of cavities of plastic components which is simultaneous with the manufacture is thus made possible.

The first compound here can be any customary starting substance or respectively any substance mixture which is usually used for the production of plastic components. The second compound can likewise be any desired material or respectively any desired substance combination, which can be transported through a line system arranged in the body. The second compound can form a foam in the cavity for example on exiting out of the body or the line system. As described below, for this the second compound can be mixed in the body from several components. However, it is also possible to guide a single-component compound through the lines, or a compound which was mixed from various components before entry into the line system.

The dimensions of the body and of the line system are limited here only by the respective field of application, i.e. by the method used for plastic production, the first compound which is used and/or the second compound which is used for the filling. The form of the body and the configuration and arrangement of the line system in the body are therefore ultimately determined by the physical stresses acting on the body and the physical parameters of the compounds which are used (e.g. density, viscosity, temperature, aggregate state and suchlike). Devices constructed accordingly for the forming of a plastic component are then suitable to be used in the most varied of applications of the production of plastic components.

The device can have, furthermore, a mixing device which is arranged in the body at the end of the body and is connected with the line system, wherein the line system has at least two lines which are suitable for the feeding respectively of a mixing component to the mixing device, and the mixing device is suitable for producing, from the mixing components which are fed to it, the second compound by mixing, and for expelling it out of the body.

The line system therefore does not necessarily have to be designed only for the transport of the second compound through the body, but rather can open out in a mixing device, which is arranged in the body in such a way that it produces the second compound by mixing and brings it out of the body. This is advantageous especially when the second compound only arises through a reaction between different, e.g. fluid, mixing components, e.g. when the second compound is a single- or multi-component reactive plastic (polyurethane, for instance). The number of mixing components advantageously amounts here to two, in order to enable a simple construction of the device. However, if required, more than two feed lines can also be provided for more than two mixing components. In a particularly simple configuration, the feed lines can be formed by recesses in the body. However, depending on the mixing component which is to be conveyed, special, e.g. particularly resistant lines can be let into the body.

Through the arrangement of the mixing body directly at the outlet for the second compound, or respectively through the letting out from the mixing device directly, it is guaranteed that a reaction takes place in the second compound, which e.g. leads to the forming of a foam or to the hardening of the mixing components, after the expulsion of the second compound. Hereby, on the one hand a damage to the device is prevented, and on the other hand it is guaranteed that the filler which is brought out from the device has the correct characteristics, whereby the quality of the produced plastic component is improved or respectively ensured.

The mixing device can be suitable for the static or dynamic mixing of mixing components at a pressure of less than 100 bar, preferably of less than 50 bar or 20 bar. The mixing device therefore constitutes a low pressure mixer, in which the preferably fluid mixing components are mixed with one another at a relatively low pressure. For example, a static mixing device can be used in which the mixing components, directed through fixed structural parts of the mixing device, flow into one another and intermix. However, dynamic mixing devices can also be used, in which movable structural parts of the mixing device bring about or assist the mixing of the mixing components. Such low pressure mixing devices have the advantage that less high manufacturing requirements have to be placed upon them, in particular with regard to the pressure resistance of the mixing device and of the feed lines which are connected with it. Thereby, the production becomes simpler and hence more favourably priced.

However, the mixing device can also be suitable for mixing the mixing components by high pressure counterflow injection with a pressure of more than 100 bar. In this case, the mixing device consists substantially of a nozzle through which the mixing components are brought out with such a high pressure that a complete intermixing takes place. This expands the applicability of the device, but also leads to higher requirements which regard to the pressure resistance of the line system which is used.

One of the lines can be suitable for the feeding of a polyol, and another of the lines for the feeding of an isocyanate. The mixing device can then be suitable for producing a polyurethane foam from the fed polyol and isocyanate by mixing and expelling out of the body. Thereby, the device is suitable in particular for use in tools for the production of plastic components which are to contain a heat-insulating or stabilizing filling, as is the case e.g. for the production of window profiles or refrigerator housings. A laborious, subsequent introducing of the heat-insulating filling can be hereby avoided, whereby costs can be saved.

The body can have a greater extent in one direction than in the other two directions, in particular a longitudinal extent of more than 1000 mm and a maximum transverse extent of less than 100 mm, preferably of less than 50 mm, and the line system and/or the mixing device can be suitable for expelling the second compound in the direction of the greater extent of the body. An intensively elongated body, in contrast to its transverse dimensions, has the result that a plastic part produced by being guide past the body at the end consists of finished, i.e. reacted, hardened and/or cooled plastic. The risk is therefore prevented that through the introducing of the second compound an interaction occurs between the first compound and the second compound, through which characteristics of the compounds are negatively influenced. A long body by comparison with the transverse dimensions therefore improves the product characteristics of the produced plastic component, or respectively ensures the achieving of these product characteristics.

The line system can be constructed free of valves and/or can only have feed lines, but no return lines. Thereby, as simple a construction of the device as possible is guaranteed, which makes it possible in addition to construct the device in a space-saving manner. In particular, through such a configuration, the thickness of the body can be reduced, whereby a manufacture of cavities with smaller cross-section dimensions is made possible. An impairment to the quality of the produced products is not to be feared here, because the quality in the production of plastic components in endless operation can be rapidly adjusted, so that an economically insignificant waste only has to be expected at the start of the process sequence.

In a method for the production of a device for forming a plastic component, as was described above, the device, or parts thereof, is produced by a 3D printing method or additive manufacture (e.g. laser melting or laser sintering). This makes it possible in particular to produce line systems in the body or a particularly elongated form of the body directly in an additive method, as in the 3D printing method. This facilitates on the one hand the production, and on the other hand makes possible forms for the body which would not be able to be produced by other methods.

A device for producing plastic components by means of pultrusion has means for producing fibre-reinforced plastic components by pultrusion and a device for forming the plastic components, as was described above. Here, the means for producing the fibre-reinforced plastic components are suitable for pultruding along the body, whereby the cavity is produced, and the end of the body from which the second compound is expelled is situated downstream in flow direction of the pultrusion.

If the device described above is used in a pultrusion tool, the mixture of endless fibre and plastic is guided past the body. By hardening along the body, the fibre-reinforced plastic component becomes dimensionally stable in such a way that at the end of the body, depending on the form of the body or the number of different bodies, one cavity or several cavities result. This or respectively these can then be filled, totally or partially, in the manner described above with the second (also different for several cavities) compound, in particular with an insulating or stability-assisting foam. In this way, it is possible in a time- and cost-saving manner to produce plastic components, produced by the pultrusion method and provided directly with a filler, such as window frames for example.

A device for producing plastic components by means of extrusion has means for producing plastic components by extrusion through an extrusion mask, and a device for forming the plastic components, as was described above. Here, the body is part of the extrusion mask and the end of the body, out of which the second compound is expelled, is situated downstream in flow direction of the extrusion.

When the device, described above, is used for the extrusion, the body of the device is the part of the extrusion mask which is arranged between the outlet openings for the different layers of the extrudate. When e.g. tubes lying in one another are extruded, the body is at least the part of the extrusion mask lying between the outlet openings of the plastic forming the respective tubes. By the introducing of a filler between the individual layers while these are extruded, a layered structure can be achieved in a rapid and simple manner, which otherwise could only be achieved, if at all, in complicated, multi-stage methods.

Although the above description is concerned principally with plastics as materials for the first compound and the second compound, it is self-evident that the same principles can also be applied to the production of elements of other materials. Thus, a device as described above can e.g. also be used in the food industry, in order to provide food forms, obtained by extrusion, with a filling.

The present invention is described below by way of example with reference to the plastic processing by means of the enclosed figures. There are shown:

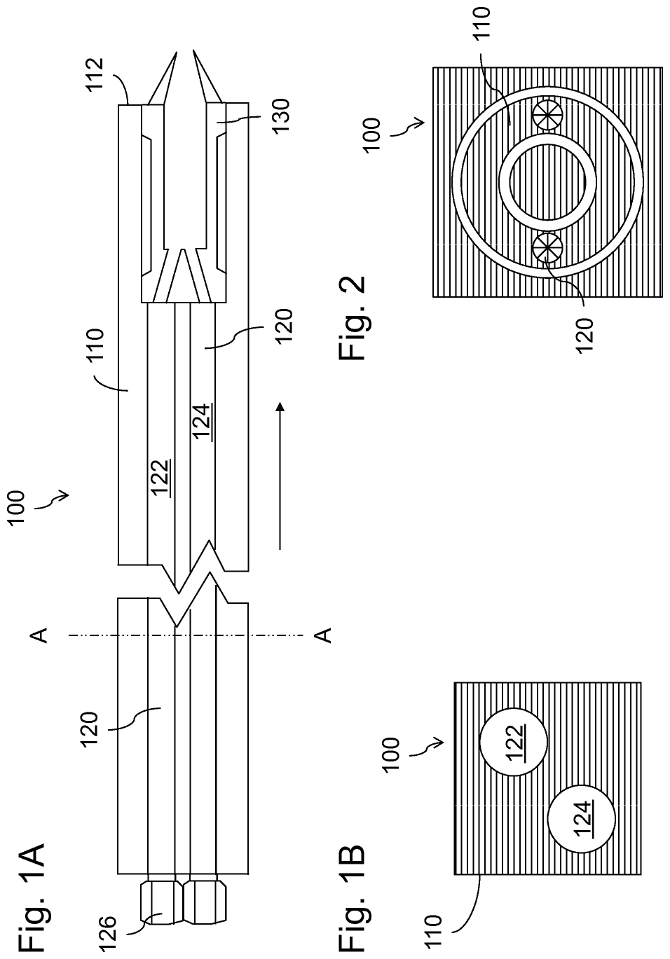

FIGS. 1A and 1B a schematic illustration of a device for forming a plastic component;

FIG. 2 a schematic illustration of a further device for forming a plastic component;

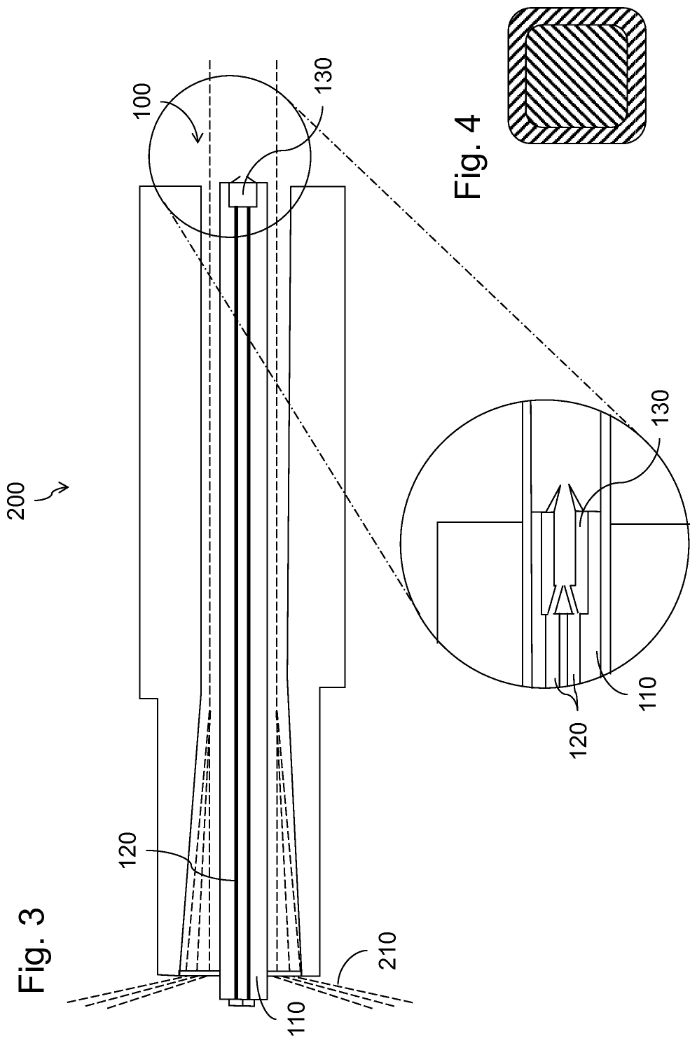

FIG. 3 a schematic illustration of a device for producing plastic components using the device shown in FIGS. 1A and 1B for forming the plastic component;

FIG. 4 a schematic illustration of a cross-section through a plastic component produced by the device shown in FIG. 3.

FIG. 1A shows a schematic side view of a device 100 for forming plastic components with a body 110 and with a line system 120 leading through the body 110. FIG. 1B shows schematically a cross-section through the device 100 along the line A-A.

The device 100 is suitable to give a form, during production, to plastic components which are produced in an endless method, by a compound from which the plastic components are manufactured, being guided past the device 100, in particular pushed past or respectively pressed past. Thus, e.g. on the device 100 a compound is guided past along the arrow shown in FIG. 1A, when the device 100 is used in an apparatus or respectively device for manufacturing or respectively producing plastic parts.

The compound from which the plastic parts are produced travels here along the body 110 towards an end 112 of the body 110 lying downstream in flow direction of the compound. The outer form of the body 110 is entirely or partially surrounded here by the compound so that, when the compound hardens to the desired plastic or reacts, an inner form of the plastic corresponds to the outer form of the body 110. With complete surrounding of the body 110 by the compound, or respectively the plastic component, therefore in the plastic part a cavity is formed by the device 100 or respectively by its body 110. When several bodies 110 are used or when the body 110 comprises forks or suchlike, plastic parts with more than only one cavity can also be produced. The compound for the production of the plastic parts here can be any desired material which is suitable for this.

The cross-section of the body 110 can have any desired form which is necessary for the plastic part which is to be produced. As shown by way of example in FIG. 1B, the body 110 can have an approximately rectangular cross-section, e.g. when the plastic parts concern component parts of window frames. The body 110 can, however, also have a round cross-section, e.g. in the production of plastic tubes. Likewise, an irregular cross-section with indentations and projections is conceivable, when this is desired for the form of the plastic component.

Depending on the field of use, the body 110 can have different lengths. For example, when the device 100 is used in a pultrusion tool, i.e. the body 110 constitutes the core of the pultrusion tool, the body 110 can be configured to be relatively long, e.g. with a length-to-width ratio of 30:1, 20:1 or 10:1. For example, a cross-section dimension of the body can be less than 100 mm or less than 50 mm, while the length of the body amounts to more than 1,000 mm. This has the advantage that a mixture of fibres and plastic (first compound) which is guided past the body 110 can cool, harden and/or react along the body 110, in order to already be sufficiently cool and/or stable (chemically and/or physically) during the filling with the second compound.

Also with a use in extrusion methods, the body 110 can have an elongated form, in order to achieve the above-mentioned advantages. However, the body 110 can also be configured to be relatively compact here and can represent the part of an extrusion mask through which the first compound is pressed. The body 110 can also have channels which allow the first compound to be partly guided through the body 110 in order e.g. to produce double-walled or multi-walled extrudates.

The form of the body 110 can therefore be adapted flexibly to the respective field of use. In this respect, the forms illustrated in the figures are only by way of example and must not be regarded as restrictive.

The line system 120 leads through the body 110 of the device 100. The line system 120 is suitable to guide through the body 110 a (second) compound differing from the (first) compound from which the plastic component is manufactured and to expel it into the cavity of the plastic component which is formed by the body 110. The line system 120 therefore ends at the end 112 of the body 110 which lies downstream in flow direction of the first (and also the second) compound. The second compound therefore arrives through the line system 120 into the cavity which is formed in the first compound or respectively the plastic component, still while the first compound is guided past the body for manufacture of the plastic component. The introducing of the second compound into the cavity therefore takes place with the use of the device 100 simultaneously with the manufacture of the plastic part.

As shown in FIG. 1B, the line system 120 can have a first line 122 and a second line 124. However, more than two or only one single line can be present in the line system 120. A plurality of lines can be present for example, in order to distribute the second compound, through expulsion from the lines, more uniformly into the cavity of the plastic part, so that a homogeneous filling occurs. In this case, it is possible that the line system 120 ends, without further components connected to the line system 120, with the end 112 of the body 110 situated downstream, i.e. lines of the line system 120 directly expel the second compound out of the body 110. Lines of the line system 120 then serve as outlet openings out of the body 110.

Especially when the second compound exiting from the body 110 is to be consist of more than one component, different materials can also be conveyed, however, in different lines of the line system 120. The arrangement of the lines in the body 110 or respectively at its end 112 can then be used e.g. to produce a layered filling of the cavity with different materials. The lines can also end directly at the end of the body 112 of the body 110 for this.

Alternatively hereto, however, it is frequently desired to introduce a mixture of several substances, for instance a foam, out of the body 110 into the cavity of the plastic component. For this, as shown by way of example in FIG. 1A, a mixing device 130 can be arranged at the end 112 of the body 110, or respectively can be formed in the latter. The line system 120 then guides to the mixing device 130 a plurality of e.g. fluid mixing components, which are intermixed by the mixing device 130 in a manner known per se. As shown in FIG. 1A, for example two lines 122, 124 can be provided, which convey two different mixing components, such as for instance a polyol and an isocyanate, to the mixing device 130.

The mixing device 130 can concern any desired component part which can be inserted into the device 100. For example, the mixing device 130 can operate in the low pressure range, i.e. at a pressure of less than 100 bar or 50 bar or 20 bar. This only places minor requirements on the stability of the mixing device 130 and of the line system 120, whereby a manufacture of the device 100 is facilitated.

The mixing device 130 can mix the plurality of mixing components statically or dynamically here. This means that the mixing device 130 is either formed in such a way that an intermixing of the mixing components is already produced solely through the configuration of fixed component parts of the mixing device 130 lying in the flow path of the mixing components (static mixer). Or alternatively or additionally, the mixing device 130 is equipped with movable component parts, which bring about or assist the mixing process through their movement (dynamic mixer).

Alternatively, the mixing device 130 can also be suitable to mix a plurality of mixing components under high pressure conditions, i.e. at more than 100 bar. For this, the mixing components are already brought to a pressure necessary for this in the line system 120 and are then mixed e.g. in a mixing nozzle by counterflow injection and are brought out from the body 110.

However, it is self-evident that in addition to the variants of mixing devices 130 described above, any other configuration can be used in the device 100 which permits introducing a mixture of several mixing components into the cavity of the plastic component which is produced by being guided past the body 100. If necessary and with sufficient space in the body 110, more than one mixing device 130 can also be provided with the corresponding feed lines in the device 100. This then permits, with correspondingly large cavities, a uniform filling with the mixed compound. Likewise, via several line systems in one or several bodies, several cavities in the formed plastic components can be filled with the same or else different compounds (respectively mixed or unmixed).

The possibility is to be particularly highlighted of filling cavities of the components, which are to be produced by the device 100, with an insulating, stabilizing foam or one having other characteristics, with the device 100 directly during the production of plastic components, which foam is provided by the mixing of several mixing components in the mixing device 130. Thus e.g. with the use of polyols and isocyanates as mixing components, a polyurethane foam can be sprayed directly into the plastic components. Through the use of the device 100 therefore plastic components filled with a heat-insulating or stabilizing material can therefore be produced in one operational step. In addition, the filling of the cavity can give the finished component still further characteristics, such as e.g. a changed thermal- or sound conductivity or changed elasticity- or shear moduli.

In order to enable a simpler manufacture of the device 100, the line system 120, formed in the body 110, can be formed without valves situated in the body, i.e. the line system 120 is connected to storage containers for the second compound or respectively for mixing components for their production via connection valves 126 provided outside the body 110 at an end of the body 110. As soon as the compound/the components have been introduced into the body 110, they flow towards the end 112 with the mixing device 130 or respectively outlets. In this sense, the device 100 can also be formed without return lines which serve for directing substances back out of the body 110 to storage containers. Thereby, a structure of the device 100 is achieved which is simple and is able to be produced at a favourable cost.

The device 100 can be produced in particular by an additive method, such as e.g. a 3D printing method. This allows e.g. forming the line system 120 directly in the body 110, without having to mill or drill it out of the body 110. Thereby, bodies 110 with a great length can be produced, which are completely penetrated by line systems 120 in longitudinal direction, and are not able to be realized by other manufacturing methods, or only with great effort. In addition, the use of 3D printing methods permits configuring the outer form of the body 110 almost in any desired manner, whereby it becomes possible to use devices 100 for the forming of plastic components as were described above in a wide range of production of plastic components.

As already mentioned above, the device 100 can be used e.g. as part of an extrusion mask or as core of a pultrusion device.

FIG. 2 shows e.g. a cross-section through an extrusion mask with the device 100, which can be used for the production of double-walled tubes. The first compound from which the tube walls are produced is pressed here through the two brightly illustrated rings. In this case, the body 110 can have a ring-shaped cross-section. The tube lying externally is then produced by pressing the first compound past the outer side of the body 110, while the tube lying internally is produced by pressing the first compound along the inner side of the body 110. The ring-shaped body 110 surrounds an inner part of the extrusion mask and is itself embraced by an outer part of the extrusion mask. In this case, it is also possible to manufacture the inner tube from a different material to the outer tube. Alternatively, the body 110 can also constitute the entire extrusion mask and have channels through which the first compound is pressed through the brightly illustrated rings. The inner and outer tube are then manufactured from the same material. It is self-evident that through the use of different, correspondingly formed bodies, also any other desired form of plastic parts can be extruded. In particular, forms with more or fewer than two walls can also be extruded in any desired configuration.

FIG. 2 shows by way of example two outlet openings of a line system 120 which is present in the body 110. These serve to fill uniformly with the second compound the cavity lying between the two tubes manufactured by extrusion. It is self-evident that systems with one or more than two outlet openings are also possible. The compounds which are brought out from the outlet openings can differ here, or else be identical.

Mixing devices 130 can also be arranged in the outlet openings. For example, the line system 120 can end in each of the outlet openings in a mixing device 130, as was described above with reference to FIG. 1A. This permits component mixtures to also be introduced into the extrudate, e.g. a reactive plastic such as polyurethane, for instance.

The extent of the body 110 perpendicularly to the plane of the drawing of FIG. 2 can be as may be desired here. In particular, the regions of the extrusion mask separated by the extrusion openings, i.e. the brightly illustrated rings, can extend to different extents out from the plane of the drawing, in order e.g. to guide the extrudate along a ring-shaped body 110, extending further forward, still for some time before the second compound is introduced out of the line system 120 or respectively the mixing device 130 into the cavity of the extrudate formed by the body 110. Thereby, it is ensured that the plastic component is sufficiently cooled and/or stable before introducing the second compound.

The device 100 therefore makes it possible during the extrusion to fill a cavity, situated in the extrudate, such as for instance the intermediate space between two tubes, in one operational step together with the production of the extrudate. It is self-evident that depending on the extruded form, the body 110 of the device 100 and the arrangement of line system(s) 120 and mixing device(s) 130 can differ in their configuration from the example shown in FIG. 2. The concrete configuration conforms here to the actually manufactured plastic component, without impairing the basic characteristic of the device 100, at the same time to form at least one cavity in a plastic component and to fill this with a compound, for instance with an insulating or stabilizing foam.

FIG. 3 shows in a schematic manner the use of a device 100, as illustrated in FIG. 1A, in a pultrusion device 200. The use of the illustration of the device from FIG. 1A serves here only for simplification of the description. It is self-evident that any other type of configuration of the device 100 is possible, as was discussed above.

In the pultrusion device 200, endless fibres 210 (or else other semi-finished forms, inlays, fabrics or inserts) are mixed by means of known means, not illustrated in detail, with plastic(s), such as e.g. polyurethane, polyamide, epoxy resin or suchlike. By guiding this mixture, functioning as first compound, past the body 110 of the device 100, which serves as a core in the pultrusion device 200, the mixture is given a profile corresponding to the finished plastic component, e.g. a window frame profile. With a complete surrounding of the body 110 by the endless fibre/plastic mixture, therefore a cavity is formed in the plastic component, the cross-section of which corresponds to the cross-section circumference of the body 110. If required, several cores or respectively bodies 110 can also be arranged in the pultrusion device 200, which then produce several cavities in the plastic component.

A second compound, e.g. an insulating or stabilizing foam, polyurethane foam for instance, is then introduced into this cavity, e.g. at the end of the pultrusion device 200 from the end of the body 110 situated downstream in flow direction, e.g. by a mixing device 130 illustrated in enlarged form in FIG. 3, as was described above. Therefore, a cavity which is present in a plastic component can be provided with a filler directly during its manufacture, whereby a complicated and costly subsequent filling is dispensed with. The result is shown by way of example in FIG. 4, in which an internally lying filler completely fills an externally lying plastic profile.

Through a large longitudinal extent of the body 100, as was discussed above and as is illustrated schematically in FIG. 3, it is guaranteed that the plastic profile at the end of the body 110 is already sufficiently cooled and/or stable, that a filling with the desired material is possible without a problem. This permits in particular the direct filling of window profiles in their production by an endless process. For other applications, however, a more compact form of the body 110 can be sufficient.

The device 100 for forming plastic components, described above with reference to pultrusion and extrusion methods, makes it possible to provide in a simple manner with a filling the most varied of plastic components with cavities directly during their production. Thereby, subsequent production steps are dispensed with, whereby great cost savings and a quicker production are made possible. The invention which is described above by way of example is limited here only by the subject of the following claims.

### LIST OF REFERENCE NUMBERS

100 device for forming a plastic component

110 body

112 end of the body

120 line system

122 first line

124 second line

126 connection valves

130 mixing device

200 pultrusion device

210 endless fibres

What is claimed is:

1. A device (100) for forming a plastic component, wherein the device (100) has:
a body (110) which is suitable for use in a device for producing plastic components from a first compound and which is formed in such a way that, when used in the device for producing plastic components, by being guided past the body (110), the first compound is brought into a form which has at least one cavity which is continuous in the direction of guiding past;
wherein
a line system (120) arranged in the body (110), through which a second compound can be expelled from an end (112) of the body (110), in order to introduce the second compound into the cavity, while the first compound is guided past the body (110), furthermore having
a mixing device (130), which is arranged in the body (110) at the end (112) of the body (110) and is connected with the line system (120); wherein
the line system (120) has at least two lines (122, 124), which are suitable for feeding respectively a mixing component to the mixing device (130); and
the mixing device (130) is suitable to produce the second compound by mixing from the mixing components which are fed to it, and to expel it from the body (110), wherein
the mixing device (130) is suitable for mixing the mixing components by high pressure counterflow injection with a pressure of more than 100 bar.

2. (canceled)

3. The device (100) according to claim 1, wherein
the mixing device (130) is suitable for the static or dynamic mixing of mixing components at a pressure of less than 100 bar.

4. (canceled)

5. The device (100) according to claim 2, wherein
one of the lines (122, 124) is suitable for feeding a polyol and another of the lines (122, 124) is suitable for feeding an isocyanate; and
the mixing device (130) is suitable to produce a polyurethane foam from the fed polyol and isocyanate by mixing and expelling from the body (110).

6. The device (100) according to claim 1, wherein
the body (110) has a greater extent in one direction than in the other two directions, with a longitudinal extent of more than 1,000 mm and a maximum transverse extent of less than 100 mm; and
the line system (120) and/or the mixing device (130) is suitable to expel the second compound in the direction of the greater extent of the body (110).

7. The device (100) according to claim 1, wherein
the line system (120) has no valves and/or only feed lines, but no return lines.

8. A method for the production of a device (100) according to claim 1, wherein
the device (100) or parts thereof is produced by a 3D printing method or additive manufacture.

9. A device (200) for producing plastic components by means of pultrusion, having:
means for producing fibre-reinforced plastic components by pultrusion; and
a device (100) for forming the plastic components according to claim 1; wherein
the means for producing the fibre-reinforced plastic components are suitable to pultrude along the body (110), whereby the cavity is produced; and
the end (112) of the body (110) from which the second compound is expelled is situated downstream in flow direction of the pultrusion.

10. A device for producing plastic components by means of extrusion, having:
means for producing plastic components by extrusion through an extrusion mask; and
a device (100) for forming the plastic components according to claim 1; wherein
the body (110) is part of the extrusion mask; and
the end (112) of the body (110) from which the second compound is expelled is situated downstream in flow direction of the extrusion.
